(19) United States
(12) Patent Application Publication
(10) Pub. No.: US 2015/0363954 A1
(43) Pub. Date: Dec. 17, 2015

(54) OPTIMIZED SERIAL TEXT DISPLAY FOR CHINESE AND RELATED LANGUAGES

(71) Applicant: Spritz Technology, Inc., Wakefield, MA (US)

(72) Inventors: Maik Steffen Maurer, Ismaning (DE); Andrew Qian, Action, MA (US)

(73) Assignee: Spritz Technology, Inc., Wakefield, MA (US)

(21) Appl. No.: 14/742,385

(22) Filed: Jun. 17, 2015

Related U.S. Application Data
(60) Provisional application No. 62/013,441, filed on Jun. 17, 2014.

(51) Int. Cl. G06T 11/60; G06F 17/22; G06T 13/80

(52) U.S. Cl. CPC G06T 11/60; G06T 13/80; G06F 17/2229; G06T 2207/30176; G06T 2207/20012

(57) ABSTRACT

Various embodiments are disclosed for optimizing serial display of text comprising Chinese characters (which appear in Chinese and in other languages). Some embodiments comprise parsing a Chinese text into display elements for serial display, each display element comprising a short phrase (generally one or two words) that is five or fewer characters in length. In some embodiments, this includes parsing the text into sentences and words and then analyzing sequences of words as part of parsing the text into short phrases (generally one or two words in length) for creating display elements that are five or fewer Chinese characters in length. In some embodiments, various aspects of the text are analyzed to determine whether and how to vary display time of a display element from a default display time. In some embodiments, phrases are displayed such that an optimal recognition positing of the displayed phrase is located at a fixed display location. These and other embodiments are more fully described herein.

### CROSS-REFERENCE TO RELATED APPLICATIONS

This application claims the benefit of U.S. Provisional Application Ser. No. 62/013,441 file Jun. 17, 2014. The entire contents of that application is hereby incorporated herein by reference.

### TECHNICAL FIELD AND BACKGROUND OF THE INVENTION

The present invention relates to apparatuses and methods for enabling improved reading in an electronic display.

Despite significant advances in digital technology, the illustration of textual information has not fundamentally changed. Texts are typically displayed in lines such that the reader's eye moves sequentially from word to word. With each eye movement (“saccade”), time is spent refixating the eye on the new word in order to recognize and process its meaning. The fixation takes about 240 milliseconds (“ms”) per word on average. Only 20% of the time for fixation is used for processing the content. It is also very common that a saccade does not reach the correct fixation point, so additional eye movement is required for reading a word.

One electronic display technique for reducing saccades is Rapid Serial Visual Presentation, hereinafter referred to as “RSVP.” RSVP was first introduced in the 1970s as a technique for presenting text one word at a time in a display. Many references since then have provided information on the use of RSVP in a variety of applications. Commercially available products based on RSVP include “Zap Reader” (www.zapreader.com/reader) and “Spreeder” (www.spreeder.com). Some prior methods exist for improving the effectiveness of an RSVP by varying the display time of a word in the display based on word length and word capitalization (see, U.S. Pat. No. 6,130,968 to McIan et al. (“McIan”)) and based on word frequency (see WO/37256 by Goldstein et al. (“Goldstein 2002”)). While these techniques are beneficial in improving comprehension of the displayed text, none of these teach how to minimize saccade movement during the presentation of a word or words in the RSVP display. Moreover, none of these techniques adequately take into account the nature of text written in Chinese characters.

RSVP has been used for electronically displaying text written in Chinese characters. However, the opportunities for optimizing RSVP display of Chinese and other languages based on Chinese characters have not yet been adequately explored.

### SUMMARY

Because Chinese and other languages based in whole or in part on Chinese characters are structured differently than English and other alphabet-based languages, different techniques are required for optimizing rapid serial visual presentation (“RSVP”) display of Chinese and related languages. For ease of description, embodiments of the present invention and the relevant principles are described in the context of Chinese only. However, many of the techniques described herein are relevant to other languages that use Chinese characters or characters derived from Chinese characters.

Commonly owned U.S. application Ser. No. 13/547,982 (now U.S. Pat. No. 8,903,174) the entire disclosure of which is herein incorporated by reference, describes certain techniques for optimizing RSVP display. As described in that application, conventional RSVP reduces saccades but does not eliminate them. Therefore, that application set forth techniques for an improved RSVP display that locates an optimal recognition position (“ORP”) of serially displayed words at a fixed location within the display. In order to prevent or minimize recovery saccades in an RSVP, it is preferable to display each word such that the optimal fixation position does not shift in the display. The focal point of the reader can then remain fixed on the optimal fixation position, which is a specific point in each word that is determined by the total number of characters or width of the word. This optimal recognition position, hereinafter referred to as the “ORP,” can be identified in the display such that the reader's eyes are directed to focus there as the words are serially presented. RSVP display that presents the ORP of each display element (e.g., word or phrase) at a fixed location on the display (i.e., the ORP of each serially presented display element is presented at the same location) allows text to be presented at a faster rate because no saccades occur during the presentation.

RSVP has been implemented at least in test setups for Chinese readers (see, e.g., Wang C X et al., “A comparison of Chinese reading parameters among rapid serial visual presentation, full screen and printed displays”). Conventional representation of Chinese text does not contain word separation by blanks Therefore, the words have to be separated from each other before being displayed in RSVP.

Some studies suggest that a preferred viewing position for a word in Chinese reading is left of middle (see, Xingshan Li, Pingping Liu, Keith Rayner: Eye movement guidance in Chinese reading: Is there a preferred viewing location?, Vision Research 51 (2011) 1146-1156)). For Chinese readers the spatial extent of visual processing during a fixation is 1 character to the left and 2-3 characters to the right of fixation (C.-H. Tsai & McConkie, 1995; Inhoff & Liu, 1997, 1998). More than 70% of all Chinese words are shorter than three characters. And less than 1% of all Chinese words are longer than four characters. Therefore, more than 99% of all Chinese words will fit into the spatial extent of visual processing during a single fixation.

Some embodiments of the invention comprise parsing a Chinese text into display elements for serial display, each display element comprising a short phrase (generally one or two words) that is five or fewer characters in length. In some embodiments, this includes parsing the text into sentences and words and then analyzing sequences of words as part of parsing the text into short phrases (generally one or two words in length) for creating display elements that are five or fewer Chinese characters in length.

Some embodiments of the invention comprise using a relative display time multiplier for each display element based at least in part on the display element's length. The relative time display multiplier is used in determining a display time for the display element (comprising a word or phrase). In some embodiments of the invention, blank elements are inserted between first and second sentences and displayed for a length of time that varies based on a word length of the first sentence. However, in a primary embodiment illustrated herein, blank elements are not displayed, but rather the last phrase of a sentence is displayed for a longer time than other phrases in the sentence. In some embodiments, a last display element of a sentence (which generally comprises a phrase and sentence-ending punctuation) is displayed for a longer time than other display elements in the sentence and the length of time varies if the word-length of the sentence is greater than a pre-determined number of words. In other embodiments, either a blank elements between sentences or a last phrase of a sentence is displayed for a fixed time relative to a selected reading speed (i.e., it does not vary based on sentence length).

In some embodiments of the present invention, the display time for a display element depends in part on the complexity and/or the use-frequency of its characters. In Chinese, the simplest character consists of a single stroke and the most complicated character includes more than 30 strokes (Togawa et al., 2000). Frequently used characters typically contain fewer strokes than do rarely-used characters. The average amount of strokes per character is approximately ten for the approximately 2,000 characters required for daily use. Thus, in some embodiments, characters containing more than ten strokes can be defined as being complex. In some embodiments, the use frequency of the word or words in a display element is used in determining a display time. In some embodiments, the use frequency of a phrase in a display element is used in determining a display time of the display element.

One embodiment of the present invention provides a method for serially displaying text on an electronic display comprising identifying an optimal recognition position for a plurality of display elements to be displayed and serially displaying the plurality of display elements (e.g., one or two word Chinese phrases comprising five or fewer Chinese characters) such that the optimal recognition position of each display element is displayed at a fixed display location on the electronic display. In one embodiment, the optimal recognition position is identified as a character in the phrase. In another embodiment, the optimal recognition position is identified as a proportionate position relative to the display width of the phrase. In some embodiments, visual aids are used to mark the fixed display location (e.g., hash marks) and/or an optimal recognition position within the phrase (e.g., different colored font).

Some embodiments comprise a computer program product including instructions for displaying text in accordance with principles of the present invention. Some embodiments comprise a computer program product including instructions for preparing and streaming text to be displayed in accordance with principles of the present invention. Some embodiments comprise an apparatus configured to carry out serial text display in accordance with principles of the present invention. Some embodiments comprise an apparatus (e.g., a computer system) configured to prepare and stream text to be displayed in accordance with principles of the present invention.

These and other embodiments are more fully described below.

### BRIEF DESCRIPTION OF THE DRAWINGS

The novel features of the invention are set forth in the appended claims. However, for purpose of explanation, several aspects of a particular embodiment of the invention are described by reference to the following figures.

FIG. 1 illustrates a text display system in accordance with an embodiment of the present invention.

FIGS. 2a-d illustrate the display portion of the embodiment of FIG. 1. FIGS. 2a and 2b show examples of the display area before presentation of text, and FIGS. 2c and 2d show two examples of displayed words/phrases of different lengths.

FIG. 3 illustrates an architectural block diagram of an embodiment of the present invention.

FIG. 4 provides a flow chart architectural diagram of the embodiment of FIG. 3.

FIGS. 5a and 5b illustrate display time multipliers for display elements (FIG. 5a) and blank elements (FIG. 5b).

FIGS. 6a-6d are flow chart diagrams of text pre-processing in accordance with an embodiment of the present invention.

FIG. 7 is a flow chart diagram of text display processing according to an embodiment of the present invention.

FIG. 8 is a flow chart diagram of processing and display of text according to an alternative embodiment of the present invention.

FIG. 9 shows a display in accordance with an embodiment of the present invention, including user controls and indicators.

### DETAILED DESCRIPTION OF THE INVENTION

The following description is presented to enable any person skilled in the art to make and use the invention, and is provided in the context of particular applications and their requirements. Various modifications to the exemplary embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles and features disclosed herein.

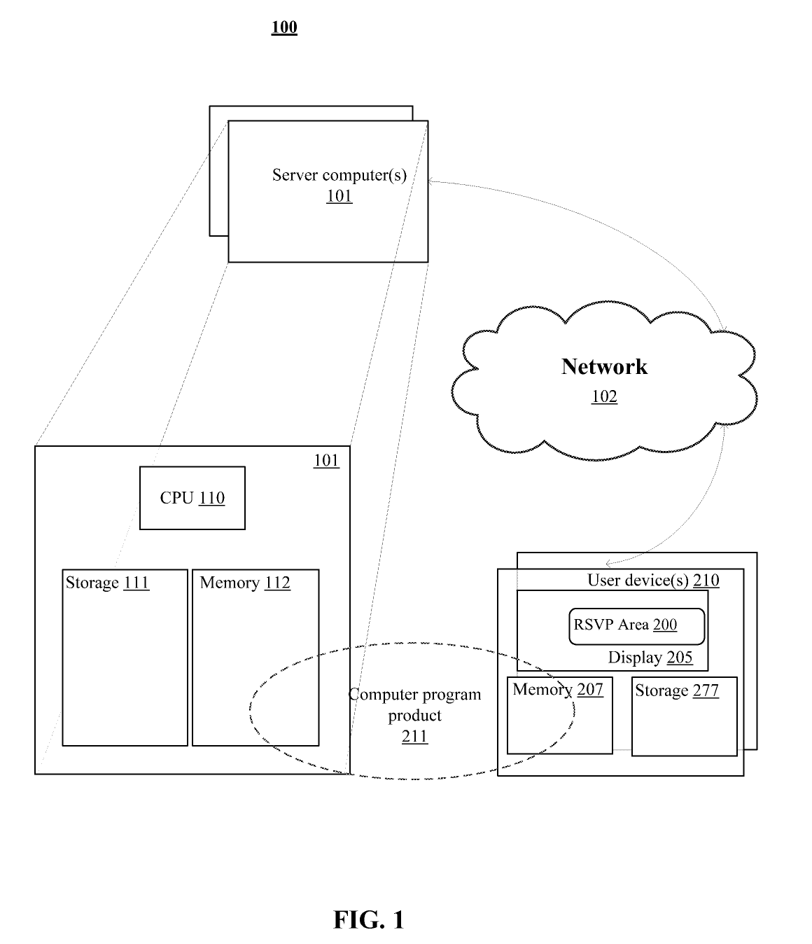

FIG. 1 illustrates a computer system 100, according to an embodiment of the present invention, for serially displaying text. Computer system 100 includes one or more server computers 101, network 102, one or more user devices 210 and computer program product 211. Computer program product 211 may be provided in a transitory or non-transitory computer readable medium; however, in a particular embodiment, it is provided in a non-transitory computer readable medium (e.g., persistent (i.e., non-volatile) storage, volatile memory (e.g., random access memory), or various other well-known non-transitory computer readable mediums).

User device 210 includes display 205, memory 207, and storage 277. Display 205 may be implemented as a touch screen display but is not limited to that. Display 205 further includes designated Rapid Serial Visual Presentation (“RSVP”) display area (DRDA) 200 on display 205. User device 210 also includes a processor and an input/output subsystem, which are not separately shown to avoid over-complicating the drawings.

Server computer 101 includes central processing unit (CPU) 110, storage 111 and memory 112. Server computer 101 may be any computing device capable of hosting computer product 211 for access by one or more client computers such as, for example, user device 210, over a network such as, for example, network 102 (e.g., the Internet). Server computer 101 communicates with one or more client computers via the Internet and may employ protocols such as the Internet protocol suite (TCP/IP), Hypertext Transfer Protocol (HTTP) or HTTPS, instant-messaging protocols, or other protocols.

Memory 112 and 207 may include any known computer memory device. Storage 111 and 277 may include any known computer storage device.

Although not illustrated, memory 112 and 207 and/or storage 111 and 277 may also include any data storage equipment accessible by the server computer 101 and user device 210, respectively, such as any memory that is removable or portable, (e.g., flash memory or external hard disk drives), or any data storage hosted by a third party (e.g., cloud storage), and is not limited thereto.

User device(s) 210 and server computer(s) 101 access and communicate via the network 102. Network 102 includes a wired or wireless connection, including a Wide Area Networks (WANs) and cellular networks or any other type of computer network used for communication between devices.

User device 210 may include any type of electronic device capable of controlling text display. Some examples include desktop computers and portable electronic devices such as mobile phones, smartphones, multi-media players, e-readers, tablet/touchpad, notebook, or laptop PCs, smart televisions, smart watches, head mounted displays, and other communication devices. In some implementations (e.g., a smart phone or e-reader), the display 205 may be packaged together with the rest of device 210. However, in other implementations, a separate display device (e.g., a monitor) maybe be attached to device 210. While the illustrated embodiment shows a graphical border around DRDA 200, DRDA 200 simply refers to a region (e.g., a window) on display 205 where text is serially presented in accordance with an embodiment of the present invention and in particular implementations, DRDA 200 may or may not be outlined by a graphical border.

In the primary embodiment described herein, computer program product 211 is loaded into memory 207 to configure device 210 in accordance with the present invention and the described processing of text for display is carried out on device 210. In such an embodiment, text data is loaded into memory for text processing and display processing by device 210 as will be further described herein. Text data loaded into memory for text processing and display processing may be retrieved from persistent storage on a user device such as storage 277 on device 210 and/or may be received from one or more server computers 101 through a connection to network 102 (e.g., the Internet). In an alternative embodiment, at least some processing/pre-processing of text data for display in accordance with the principles illustrated herein may be carried out by one or more remote computers such as server computers 101 and then sent to end user device 210 for display in DRDA 200 on display 205. In such an alternative, some or all of a computer program product such as computer program product 211 for implementing an embodiment of the present invention may reside on one or more computers such as server computers 101 that are remote from end user device 210. In some embodiments, the entire computer program product may be stored and executed on remote computers and the results presented within a browser application component (e.g. a media player application) of user device 210 (browser application and media player application not separately shown).

Although not illustrated, user device 210 also includes, as referenced above, a processor and an input and output subsystem. In some implementations (e.g., a smart phone or e-reader), user device 210 includes a wireless transceiver and one or more input interfaces including a touch enabled display, a trackball, keyboard, microphone, smart television controller, etc.

In an embodiment of the invention, text (which includes, for example, strings of characters—e.g., letters, Chinese characters, numbers, symbols, etc.—which constitute words, numeric figures, and combinations of both with punctuation marks and symbols—note that words may include words represented by any human language including, without limitation, words represented by roman characters, script elements, or pictographic characters—) is presented serially (for example, one word or one short phrase at a time) within DRDA 200. As referenced herein, a “display element” will refer to a group of text data that is displayed at one time within DRDA 200 and, in the context of Chinese characters, will generally include a short phrase. An embodiment displays display elements one after the other, i.e., serially.

In a conventional RSVP system, each word is centered in the display area, and the optimal fixation position shifts as words of differing lengths are sequentially displayed, resulting in saccade movements as the eyes shift to the optimal fixation position. The reader has to refocus on the display every time a new display element appears that is of a different length than the previous display element. The reader's eyes will move from one character to the next to find the optimal position, which is also referred to as a recovery saccade. In addition, when a longer display element follows a shorter one, the saccadic movement direction will be from right to left. When reading text in lines in a traditional paragraph display, most saccadic movement is from left to right so the reader is accustomed to this type of eye movement. Only occasionally, if the optimal fixation position is not found directly, the reader may have to move back from right to left. Thus conventional RSVP forces the reader to experience saccades which are not normal. Conventional RSVP approaches offer no solution to these problems. In order to prevent or minimize recovery saccades in an RSVP, it is preferable to display each word such that the optimal fixation position does not shift in the display. The focal point of the reader can then remain fixed on the optimal fixation position, which is a specific point in each word that is determined by the total number of characters or width of the word. This Optimal Recognition Position (ORP), can be identified in the display such that the reader's eyes are directed to focus there as the words are serially presented.

In one embodiment, configuring text content for RSVP display includes parsing the text into a plurality of display elements, inserting blank elements at the end of a sentence, and determining a multiplier for each display element that can be used, along with user selected settings and/or other display parameters, to determine a display time for each display element. While, in some embodiments, each element may be displayed for the same amount of time, it has been demonstrated empirically that a longer display time is beneficial for comprehension of longer words. It has also been demonstrated empirically that a longer pause between sentences is beneficial for comprehension of longer sentences. Further details of certain systems and methods for preparing and displaying text using RSVP are described in commonly-owned U.S. application Ser. No. 13/547,982 (issued as U.S. Pat. No. 8,903,174) referenced above.

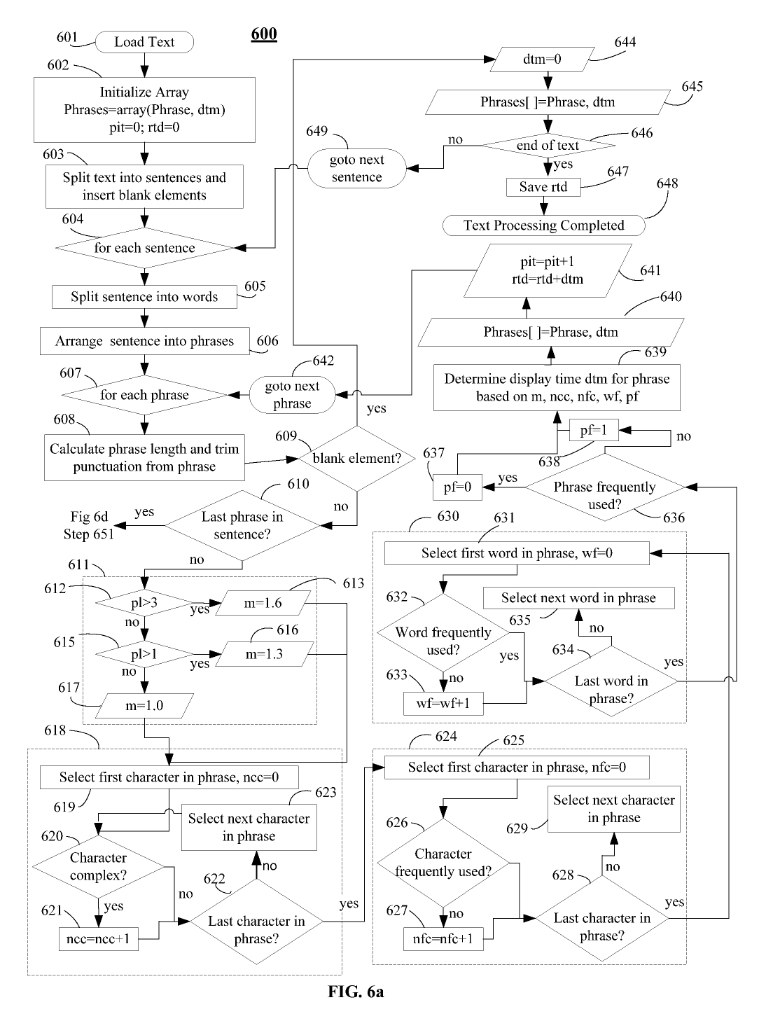

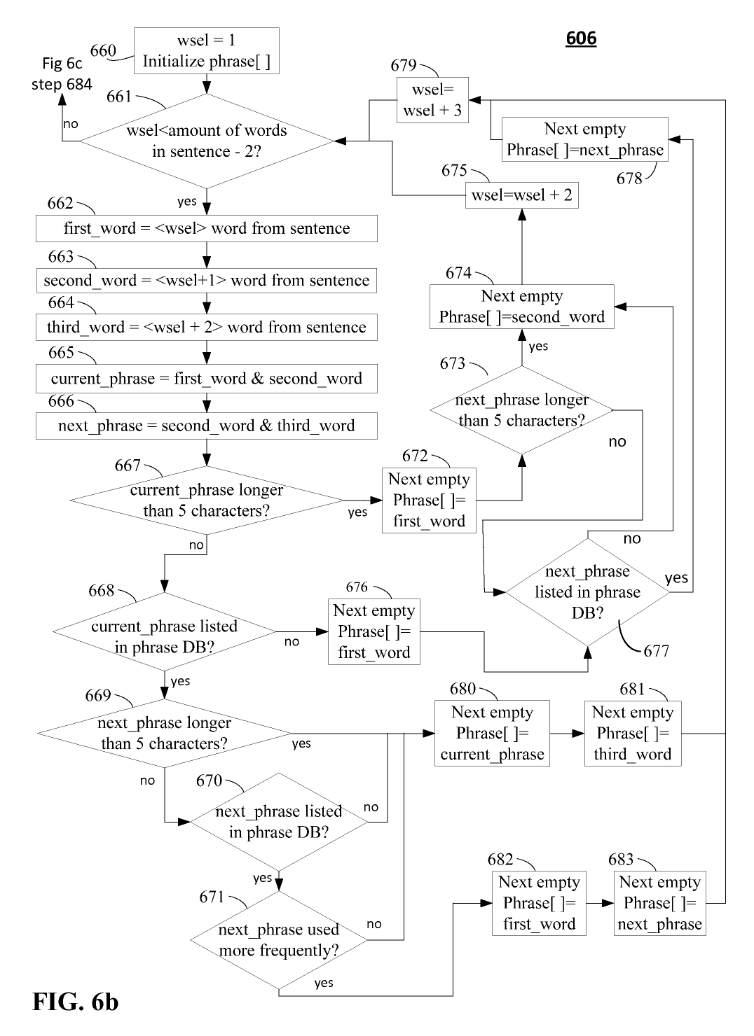

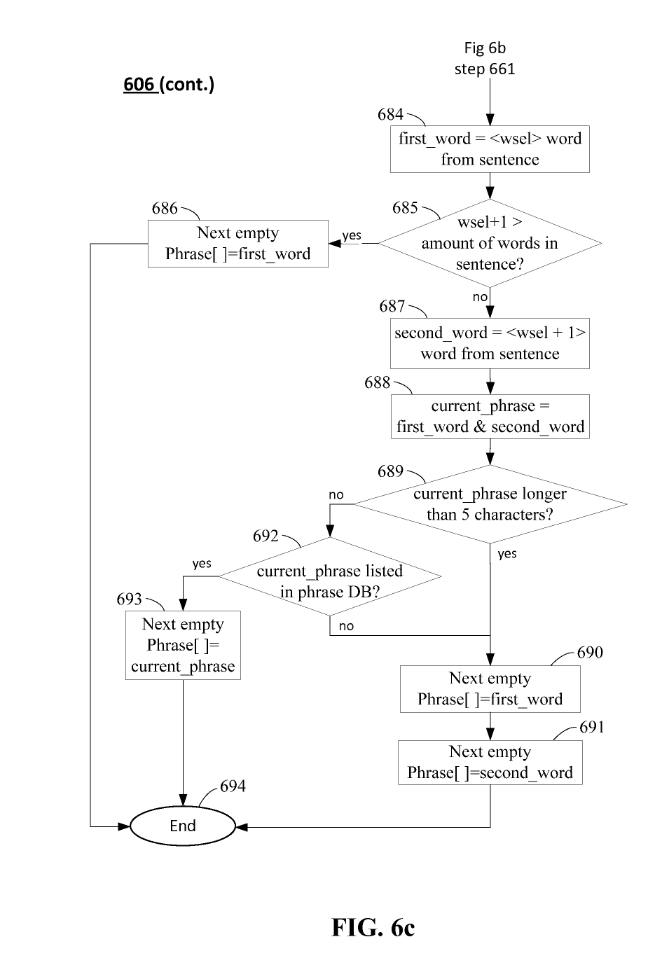

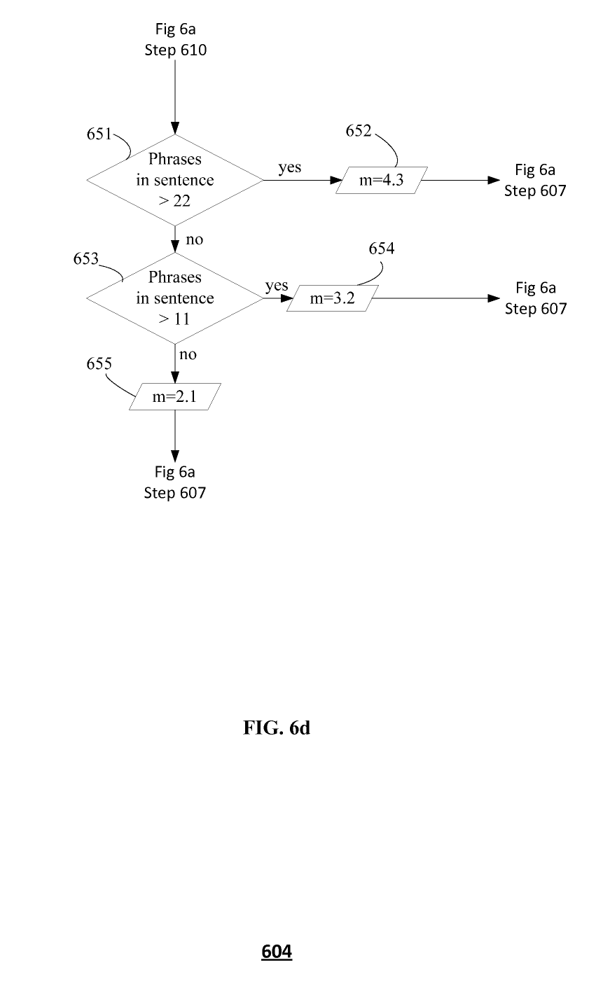

Conventional representation of text in Chinese language, e.g. in printed form or in digital display does not present spaces between words. Readers often think in phrases instead of single words. Single Chinese words can often have several meanings; however, their meaning in the context of a phrase is easier to determine. Therefore, although some Chinese words may have clear meaning standing on their own, some words, particularly depending on the context, may be significantly easier to understand as part of a phrase. At the same time, certain phrases might be too long to avoid saccades during RSVP. Therefore, as further described in the context of FIGS. 6b-6c, a particular embodiment described herein analyzes the words in each sentence and determines whether to include two words or one in a single display element.

Most Chinese words are four characters or less in length. The visual span of Chinese readers is about four to five characters long, with one character to the left and two to three characters to the right. The ORP character position method for Chinese language centers the word or phrase to a specific character depending on the length of the displayed word or phrase as shown in TABLE 1. This definition of the ORP character position takes into account the asymmetric visual span of readers and the extend of the visual span for reading Chinese text. Punctuation marks which may occur after a word or phrase are not counted to the total number of characters for determination of the ORP Character Position.

TABLE 1

| Total Number | ORP Character | ORP Character |
|---|---|---|
| of Characters | Position | Position Ratio |
| 3 | 2 | 0.50 |
| 4 | 2 | 0.375 |
| 5 | 2 | 0.30 |
| >5 | NA | NA |

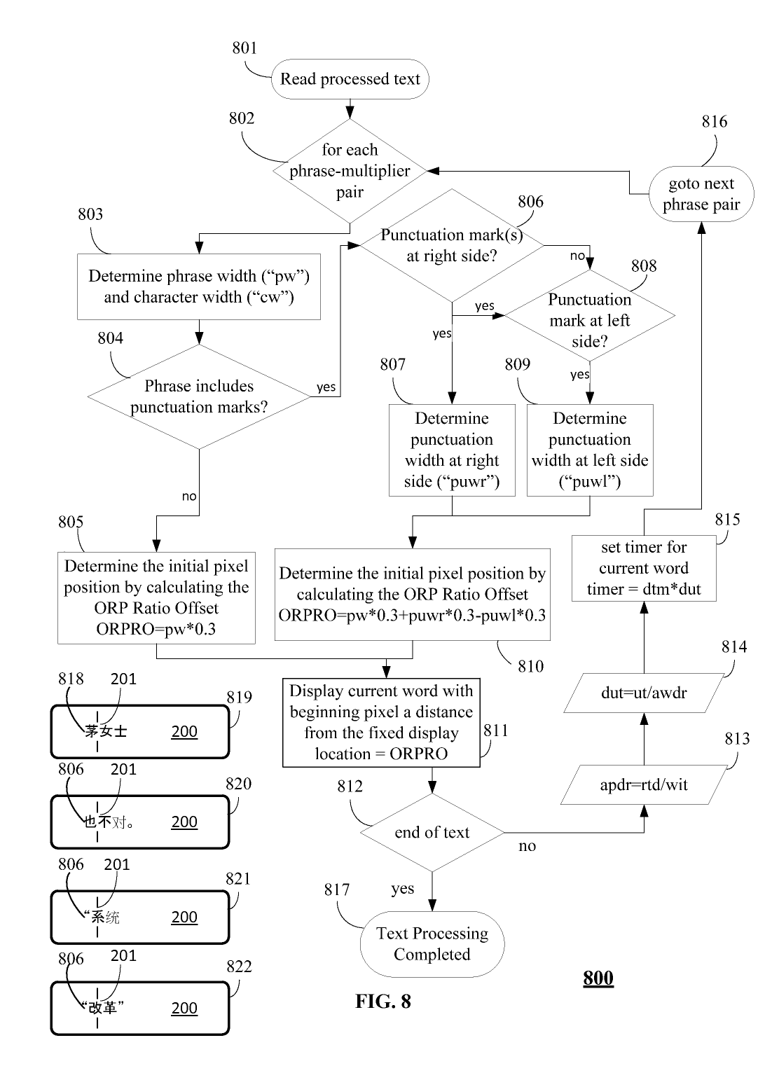

Table I also shows the ORP Character Position Ratio for displaying Chinese text. The ORP Character Position Ratio value above is the proportion of the word that is to the left of the middle of the ORP character (e.g., if second character is centered at the fixed display location for the ORP, then 1.5 characters are to the left of that location) (note that in commonly owned U.S. application Ser. No. 13/547,982, issued as U.S. Pat. No. 8,903,174, a similar table value was calculated differently, based only on the number of whole characters to the left of the ORP character—therefore, in that application, an ORP Offset formula included accounting for the half-character width of the ORP character that was not accounted for in the table value. By contrast, the character position ratios in Table I above already account for the half-character width of an ORP character to the left of the fixed display location. Consistent with that, although not using the above ratio values in the primary embodiment, the ORP Offset formula presented herein in the context of FIG. 8 does not need to account for an additional half-character width).

In other embodiments, the ORP is determined as a proportion of the display element's (word's or phrase's) pixel width. In most displays for Chinese texts all widths of characters are identical. Therefore, the pixel width of a display element can be calculated by multiplying the number of characters in the display element with the pixel width of one character. Based on this pixel width of a display element an offset is calculated beginning with the display element in the reading direction associated with the display element. If punctuation marks are connected with the word or phrase in the display, then this can be considered for calculating the offset. Punctuation marks in Chinese texts often do not fill out the entire character width. Therefore, it is possible to only consider the visible part of the character width for calculating the display elements' offset. A detailed description of the determination of the ORP by proportional offset is shown in FIG. 8. As further described therein, the ORP Character Position Ratio shown above in Table I can be used in an alternative implementation of the ORP proportionate position method.

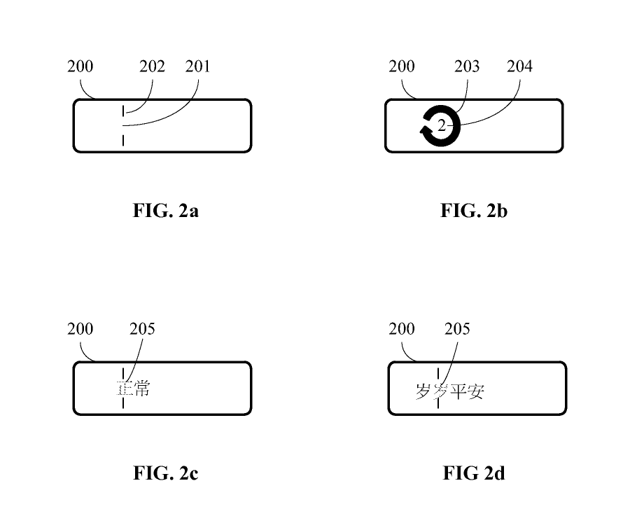

FIG. 2a shows a basic RSVP display 200 in accordance with the first embodiment of the present invention. For displaying Chinese text, the RSVP display 200 can accommodate text of up to eight characters in length, although it is preferred to limit the display to five characters for improved comprehension. Some additional room is preferred in any event because words or phrases can be displayed together with punctuation marks to the left and/or to the right of the word or phrase. In this embodiment, fixed display location 201 is positioned within the display 200 to accommodate two characters (plus any left side punctuation marks) to its left and can be identified with hash marks 202. Other identifiers such as circles, colors or textures may be used.

FIG. 2b shows how a circulating arrow 203 can be used to direct the user's eye to focus at fixed display location 201 before the words are serially presented. A countdown indicator 204 may also be utilized to indicate the amount of time before the words begin to be serially presented.

FIG. 2c illustrates positioning of the word “Hs” in RSVP display 200. When the serial presentation begins, the first word or phrase is displayed in the RSVP display 200 such that ORP character 205 is positioned at fixed display location 201. In the example in FIG. 2c, the total number of characters in the element is two and, therefore, from TABLE I, the first character “ [symbol] ” is positioned at fixed display location 201. FIG. 2d shows display of the phrase “ [symbol] ”. Based on TABLE I, the second character “ [symbol] ” is the ORP character 205 and is displayed at fixed display location 201.

A colored font, such as a red font, may be utilized to emphasize the ORP character 205, as shown in FIG. 2c and FIG. 2d. In the ORP character position method, use of a different colored font for the ORP character may be particularly useful. However, in the ORP proportionate position method, use of a different color font is not necessarily desirable because, in that method, an ORP character is not necessarily centered at fixed location 201 (as further shown and described in the context of FIG. 8).

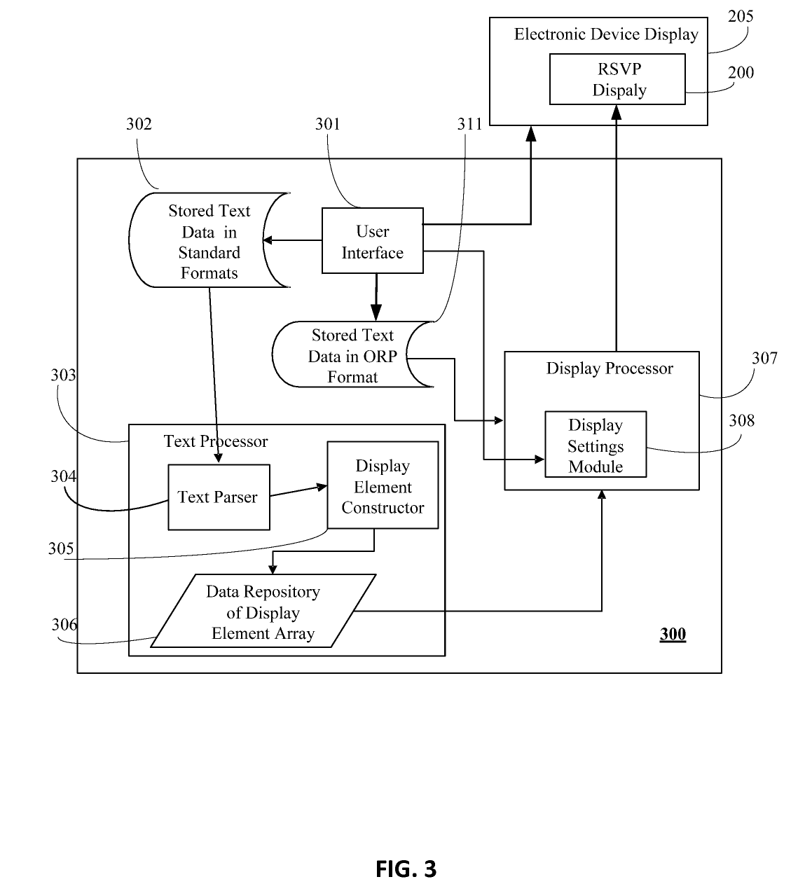

FIG. 3 is a block diagram of computer application 300 in accordance with an embodiment of the present invention to be utilized on an electronic device which includes a digital processor, memory, and a display (and/or that is adapted for communication with a separate display). Computer application 300 is designed to accomplish text display in an RSVP display such as RSVP display 200 on a display such as display 205. User interface subsystem 301 provides features for user interaction via a graphical windowing system, including, in certain cases, windows, menus, dialogs, and similar features, as well as input selection means from an input device such as a mouse, keypad, touchpad, touch stick, joy stick, touch-screen, natural user interface, or voice recognition system. User interface 301 enables the user to select text to be displayed, either in standard formats or text that has been preprocessed into the necessary ORP display format, as well as to make or change display settings. Text to be processed by application 300 may be stored in memory 302 in a variety of standard formats, such as xml, txt, pdf, and doc. The ORP text processor subsystem 303 converts the stored text into the format necessary for display by display processor 307. It contains text parser subsystem 304, display element constructor 305, and data repository 306 which stores the processed text as display elements with display parameters. Text parser subsystem includes a word segmenter and a phrase database (not separately shown in FIG. 3, but described further in the context of FIGS. 6a-6c). ORP display processor subsystem 307 accesses the text from the in-memory data repository 306 or from a stored ORP file 311 and prepares it for RSVP presentation in the RSVP display 200 on the electronic device display 205. The ORP display processor 307 also includes, in this example, display settings module 308, which enables the user to make or change display settings such as the overall speed in average words-per-minute or average display time of words.

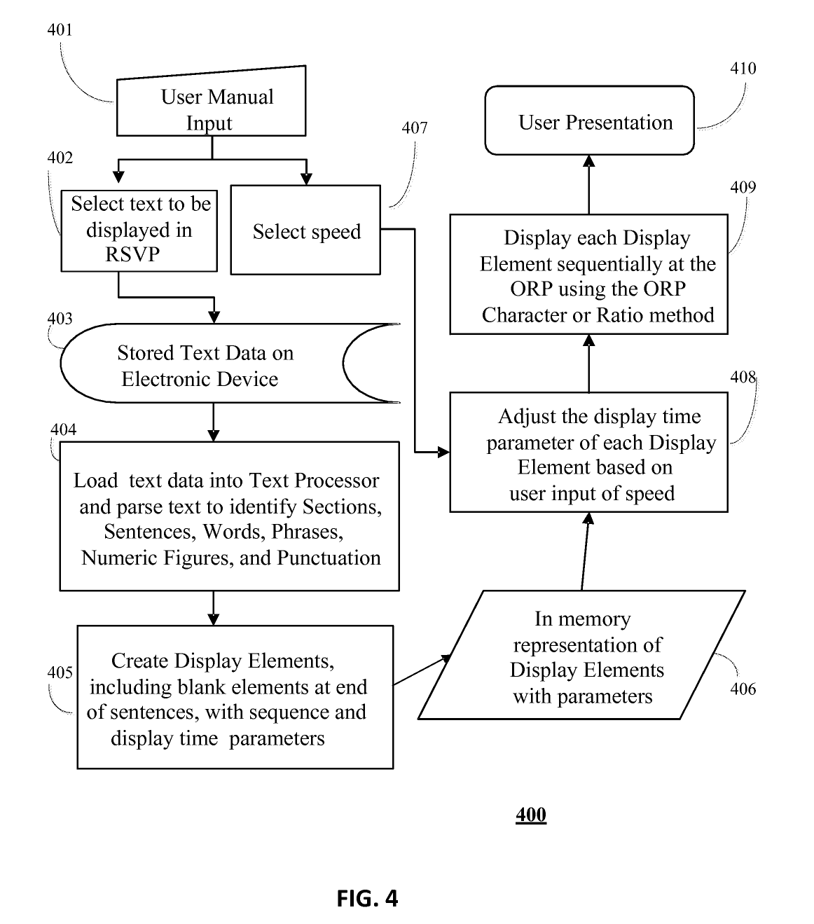

FIG. 4 provides a high level flow chart of processing 400 which implements information processing of computer application 300 of FIG. 3. A user provides user manual input 401 which is received by user interface 301 (see FIG. 3). In response to user manual input 401, step 402 selects the text to be presented. For example, a selection of a text file from a list may be made using a mouse, keypad, or touch-screen. A selection may also be made from within a full text that is currently displayed. In this example, it is assumed text selected to be displayed is stored on the electronic device. Step 403 retrieves the stored text data. However, in alternative examples, the text may be retrieved from a remote device. ORP text processor 303 then initiates step 404 to load the data and uses text parser 302 to parse the text to identify sections (such as paragraphs, chapters, etc.), sentences, words, numeric figures, and punctuation marks. Display element constructor 305 then initiates step 405 to create an array sequence of display elements, including the insertion of a blank element at the end of each sentence.

Step 405 also calculates parameters for the display time of each display element. While, in alternative embodiments, it is possible to display each element for the same amount of time, it has been demonstrated empirically that a longer display time is beneficial for comprehension of longer words. It has also been demonstrated empirically that a longer pause between sentences (than between words) is beneficial for comprehension of longer sentences.

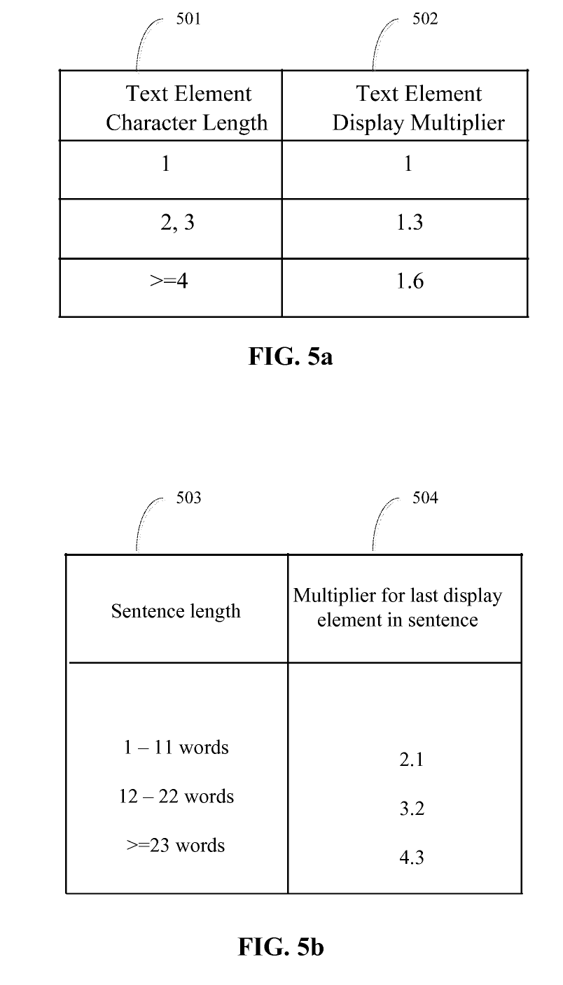

FIG. 5a provides a set of recommended values for a text element display multiplier 502 as a function of the text element character length 501 for application to Chinese language. Testing done by the inventor with native Chinese speakers has shown use of these values provides benefits to reading comprehension and therefore these values are provided for use in one embodiment of the invention. However, further empirical testing can be done to refine/modify these values and different values might be used in alternative embodiments without necessarily departing from the spirit and scope of the present invention.

FIG. 5b provides a set of recommended values for display multiplier 504 for a display element at the end of a sentence (e.g., last word or phrase of a sentence in combination with a punctuation mark such as a period, exclamation point, or question mark) as a function of the sentence length 503. Tests by the inventor using Chinese native speakers have shown that, for Chinese language, an increased display time of the last word (with the punctuation mark) in the sentence can aid in comprehension for some readers. This increased display time of the last word of the sentence is dependent on the amount of words in the sentence. The value of 2.1 for sentences up to 11 words for the display element multiplier works well. For sentences of 12 to 22 words a Display Multiplier of 3.2 is applied. And for sentences with 23 or more words a value of 4.3 is applied. It is therefore used in one embodiment of the present invention. However, further empirical testing can be done to refine/modify this value and different values might be used in alternative embodiments without necessarily departing from the spirit and scope of the present invention.

In the primary embodiment described above, a pause at the end of a sentence is achieved by displaying the last phrase (together with the punctuation mark) for a longer time based on a display multiplier. In that embodiment, no blank element is displayed prior to displaying the first phrase of the next sentence. However, in alternative embodiments, a pause is achieved by inserting and displaying a blank element between sentences. In such alternatives, multipliers such as multiplier 504 can be applied to vary the display time of the blank element based on the length of the sentences. Tests by the inventor using Chinese native speakers have shown that, for Chinese language, a short pause between sentence sentences can aid in comprehension for some readers.

Returning to the description of FIG. 4, the display parameters are then stored for each display element in the array to create the in-memory representation 406, which may also be stored as a file 311 in non-volatile memory. Step 408 adjusts the display time parameter of each display element based on a setting of the overall speed which has been selected at step 407 based on user manual input 401. As referenced above, the ORP display processor 307 includes display settings module 308 which stores the display settings, including a profile that has been previously selected by the user. In addition to the overall speed setting, the display settings may also include options for other settings, for example the initial display speed (providing a ramp from a lower speed at the start to the higher overall speed setting), the color of the display background, the color or texture of the ORP indicators, and the text font type and size. The ORP display processor 307 then carries out step 409 to display each display element sequentially for its adjusted display time with its ORP character positioned at fixed display location 201 in RSVP display 200 on the electronic device display 205 if using the ORP character position method. If using the ORP ratio position method, the ORP display processor 307 carries out step 409 to display each display element sequentially for its adjusted display time with the first character positioned at a distance from fixed display location 201 equal to the amount of the ORP offset calculated for that specific display element.

FIG. 6a is a flow chart showing method 600 which illustrates further details of processing carried by computer application 300 of the embodiment of FIG. 3. Specifically, method 600 is carried out by text processor 303 of FIG. 3. Step 601 receives text. Step 602 creates an empty array Phrases [ ] of ordered pairs for display elements (each of which comprise a single phrase, which, in the primary embodiment herein, as described further below, generally comprise either one word or two words) and their corresponding display time multipliers (“dtm”). The value of the variable “Phrase” in the array Phrases [ ] corresponds to the visible content of the display element and the value of the variable rtm corresponds to the amount by which the default display time (the default display time might, for example, be related to a reading speed selected by a user and/or other factors) for that display element will be multiplied based on the processing results of method 600. Counters for phrases-in-text (“pit”), and relative text duration (“rtd”) are initialized at 0. Step 603 parses the text to split it into sentences and inserts a blank element at the end of each sentence to provide a marker of the sentence's end. In a primary embodiments the blank element between sentences is not displayed, but can still be used as indication of a sentence end. In alternative embodiments, other markers (that are not necessarily displayed) can be inserted into the text data to indicate a sentence end to the system. In other alternatives, the presence of certain punctuation marks can be relied on (e.g., period, exclamation mark, and question mark) to determine the end of a sentence so that an additional marker does not need to be inserted. In these alternatives, the determination is subject to exceptions when a punctuation mark typically used to end a sentence (e.g., a period) is present but the sentence is not ended (e.g., “Dr.”, “Mrs.” or other abbreviations).

Step 604 selects the sentence to be processed by step 605 (which is either the first sentence on an initial processing loop, or a next sentence in response to step 649). For that sentence, step 605 splits it into words. Step 606 arranges the words of the current sentence into phrases (see FIGS. 6b-6c and accompanying text for a description of processing carried out by step 606). Step 605 and 606 can also be realized using an external library, e.g. the “Stanford Word Segmenter” (http://nlp.stanford.edu/software/segmenter.shtml).

Chinese phrases generally comprise either a single word or two words that together have a clear meaning. In some instances, a phrase may comprise more than two words, however, Chinese phrases, for purposes of embodiments of the present invention, usually include only one or two words. “Phrase” as used herein may therefore refer to either single words that have clear meaning used alone or small groups of words (usually no more than two) that, taken together, have a clear meaning.

Step 607 selects the phrase to be processed by step 608 (which is either the first phrase on an initial processing loop for a particular sentence, or a next phrase in response to step 642). For that phrase, step 608 calculates the phrase length (“pl”) with punctuation trimmed from that phrase. In this embodiment, pl is calculated without including punctuation for purposes of calculating a display multiplier and for determining an optimal recognition position character. However, alternative embodiments may utilize punctuation (or certain types of punctuation) for calculating certain display parameters, particularly to the extent particular empirical results dictate that factoring in punctuation can benefit reading results. For example, FIG. 8 illustrates and describes an embodiment that calculates an ORP offset (based on a proportionate position method rather than selecting an entire character to be centered at the ORP). In that embodiment, the width of punctuation marks is taken into account.

Continuing with the description of FIG. 6a, step 609 determines whether the current phrase is a blank element. If the answer is no, then step 610 determines if the current phrase is the last phrase of the sentence. This can be accomplished by various methods. In the primary illustrated embodiment, it is accomplished by determining whether the phrase is followed by a blank element (which is simply used in the illustrated embodiment as a marker to designate a sentence end). In alternative embodiments, other markers can be used or a sentence end can be determined based on appearance of particular punctuation marks subject to appropriate exceptions. If the result of step 610 is yes, then the method proceeds to step 651 of FIG. 6d.

FIG. 6d shows the determination of the display multiplier value for a sentence-ending phrase. Step 651 determines if the current sentence consists of more than 22 phrases. If the answer is yes, then the display multiplier m is set to 4.3 at step 652) and the process continues to step 607 of FIG. 6a. If the result of step 651 answer is no, then step 653 determines if the current sentence consists of more than 11 phrases. If the answer is yes, then the display multiplier m is set to 3.2 at step 654 and the process continues to step 607 of FIG. 6a. If the result of step 653 is no, then the display multiplier is set to 2.1 at step 655 and the process continues to step 607 of FIG. 6a.

Continuing with the description of FIG. 6a, if the result of step 610 is no, then block 611 determines the multiplier (“m”) based on the value of pl. In block 611, steps 612-617 progressively test pl until the appropriate value of m is selected. The values of m specified in steps 612 to 617 have been determined empirically, but different values could be utilized in other embodiments to provide for additional display time for phrases of varying length. Step 612 determines if pl is greater than three. If the result of step 612 is yes, then step 613 sets m to 1.6; if the result of step 612 is no, then step 615 determines whether pl is greater than one. If the result of step 615 is yes, then step 616 sets m to 1.3; if the result of step 615 is no, then step 617 sets m to 1.0.

Once m is set in block 611 (steps 612 to 617), block 618 then tests to determine if characters in the phrase are complex. Empirical studies have shown that readers of Chinese texts may focus longer on complex characters than on non-complex ones. Step 619 selects the first character of the current phrase and initiates the variable “ncc,” which counts the number of complex characters per phrase. Step 620 then determines if the character is complex. This can be done by a database query. In such a database, Chinese characters are designated as being complex or not. In one embodiment, this designation is based on the amount of included strokes per character. In one example, characters with more than 10 strokes are designated as complex. However, in alternative embodiments, different stroke criteria might be used to designate complexity. If the answer of step 620 is yes, then the variable ncc is increased by one and step 622 is executed. If the answer to step 620 is no, then step 622 is executed. Step 622 determines if the current character of the phrase is the last character of the phrase. If the answer is no, then step 623 selects the next character of the phrase. If the answer in step 622 is yes, then block 624 is executed.

Block 624 determines the number of infrequently used characters in a phrase. Step 625 selects the first character in the current phrase and initiates the variable nfc. This variable is used for specifying the number of not frequently used characters in a phrase. Step 626 then determines if the character is frequently used. This can be done by a database query. Such a database lists Chinese characters with their frequency of use. In one embodiment, the database lists use-frequency of the characters in general, without respect to the particular type of text. In another embodiment, the database lists use frequency of the characters in different specific types of text. This can allow refining the use-frequency determination based on the type of text that is being presented to the user. If the answer in step 626 is no, then step 627 increments the variable nfc by one before the method proceeds to step 628. If the answer to step 626 is yes, then the method proceeds step 628 directly. Step 628 determines if the current character is the last character of the phrase. If the answer is no, then step 629 selects the next character of the phrase. If the answer in step 628 is yes, then block 630 is executed.

Block 630 determines the number of infrequently used words in a phrase. Step 631 selects the first word in the current phrase and initiates the variable wf. This variable is used for specifying the number of words in a phrase that are used infrequently. Step 632 then determines if the word is frequently used. This can be done by a database query. Such a database lists Chinese words with their frequency of use. One example of such a database is described in: “SUBTLEX-CH: Chinese Word and Character Frequencies Based on Film Subtitles” by Qing Cai and Marc Brysbaert, available at: http://www.plosone.org/article/info%3Adoi%2F10.1371%2Fjournal.pone.0010729. The underlying data is available at http://crr.ugent.be/programs-data/subtitle-frequencies/subtlex-ch.

In one embodiment, the database lists use frequency of the words in general, without respect to the particular type of text. In another embodiment, the database lists use frequency of the words in different specific types of text. This can allow refining the use-frequency determination based on the type of text that is being presented to the user. If the answer of step 632 is no, then step 633 increments the variable wf by one and the method proceeds to step 634. If the answer to step 632 is yes, then the method proceeds directly to step 634. Step 634 determines if the current word of the phrase is the last word of the phrase. If the answer is no, then step 635 selects the next word of the phrase. If the answer in step 634 is yes, then step 636 is executed.

Step 636 determines if the current phrase is frequently used. This can be done by a database query. Such a database lists Chinese phrases with their frequency of use. In one embodiment, the database lists use frequency of the phrases in general, without respect to the particular type of text. In another embodiment, the database lists use frequency of the words in different specific types of text. This can allow refining the use-frequency determination based on the type of text that is being presented to the user. In the primary embodiment described herein, character complexity, word use-frequency and phrase use-frequency have simple binary designations (e.g., complex or not complex and frequently used or not-frequently used) and those results are used in a formula for conditionally modifying a display time based on character complexity and word and/or phrase use frequency. The inventors' research has shown that these binary designations are sufficient for providing beneficial effects on reading comprehension. However, alternative embodiments might rely on a greater number of gradations in determination of character complexity and word and phrase use-frequency and apply those determinations in a more complex formula than is illustrated in the primary embodiment. Some variations on the applied formula are further described below in the context of describing step 639.

If the result of step 636 answer is yes, then step 637 sets the variable pf to zero and step 639 is executed. If the answer is no, then step 638 sets variable pf to one and step 639 is executed.

Step 639 determines the display time multiplier (“dtm”). In one embodiment, this is done by calculating a “dtm_raw” value as dtm_raw=m+0.3(ncc+nfc+wf+pf) and then applying the following logic to determine a value for dtm:

If dtm_raw<=2: dtm=dtm_raw

if dtm_raw>2: dtm=2

Many variations on the above formula for dtm_raw are possible without departing from the spirit and scope of the present invention. For example, in alternative embodiments, a factor other than 0.3 can be used for determining dtm_raw. Also, in other alternatives, the variables ncc, nfc, wf and pf can have individual weightings that differ from each other and from 0.3. In other alternatives, only one of the variables ncc and nfc can be applied for computing the value dtm. Such an alternative recognizes that the complexity and the frequency of characters in Chinese language have a significant correlation (according to Togawa et al., 2000).

As referenced above, assessing the word frequency wf and the phrase frequency pf can be based on general statistics for Chinese texts or for sub-categories of Chinese text types. Also, the frequency can be based on customized statistics for the specific person reading the text. It's possible that a word or a phrase appears frequently for one reader, because of the texts that reader is consuming. The same word or phrase can appear rarely for another user because that reader reads different texts than the first reader. The different frequency of words or phrases can be used to determine customized display times of the word or phrase.

Step 640 saves the current phrase and its display time multiplier dtm (calculated in step 639) to the array “Phrases” (which collects the data for all phrases in the text). Step 641 increases the counter “pit,” which indicates the number of phrases in the text. Step 641 also increases the value of rtd by the amount of the value of dtm as determined in step 639. Step 642 then goes to the next phrase in the text.

If the answer in step 609 is yes (the current display element is a blank element, which follows the end of a sentence), then step 644 sets the display time multiplier (dtm) for the blank element to a fixed value, in this example, 0. Empirical studies by the inventors have shown that not showing a blank element after the sentence end works well. Therefore, in the primary embodiment, a pause between sentences is achieved by increasing the display time of the sentence's last phrase as discussed above. However, in alternative embodiments, as previously discussed, a blank element can be displayed to add a pause between sentences. Therefore, in alternative embodiments, a dtm for a blank element might be greater than zero. Step 645 saves the blank element and the associated display time multiplier to the array Phrases (note that, in this case, the value of the variable “Phrase” is simply the blank element). Step 646 determines if the end of the text is reached. If the answer is no, then step 649 goes to the next sentence in the text. If the answer to step 646 is yes, then step 647 saves the value of variable rtd and Step 644 ends the text processing.

Note that in the primary embodiment illustrated herein, the pause between sentences varies based on the sentence's word length. However, a fixed value for a pause produces acceptable results and is therefore used in alternative embodiments.

FIGS. 6b and 6c show the details of step 606 of FIG. 6a. In general, step 606 determines whether two adjacent words should be combined as a single phrase to be displayed together as a single display element. Step 606 aims to combine words into a phrase when doing so would improve comprehension of RSVP displayed text relative to keeping the words in separate display elements. FIGS. 6b and 6c show an embodiment that relies on processing of the words in a sentence in groups of three and querying a database containing Chinese phrases and their frequency of use. Depending in part on analysis of frequency of phrases made up by adjacent words and in part on the phrase length (in characters) that would result if adjacent words are displayed together, step 606 determines whether to combine adjacent words in a single display element or whether to display them separately.

In the illustrated embodiment, a phrase can either be a single word or it can consist of two words in combination, e.g., a verb and a noun. The aggregation of words to meaningful phrases is accomplished by comparing a text with a database of phrases.

Prior to step 606, step 605 (referenced in FIG. 6a) divides the sentence into words. As previously discussed, the definition of what character combinations constitute a “word” in Chinese is less fixed than in other languages such as English and this is reflected in how Chinese texts are displayed. Although some scholars have proposed introducing spacing to define words in Chinese text, Chinese text does not group characters into words with the use of spaces. For purposes of processing a text and parsing into phrases, the present embodiment makes a determination of word division in step 605 to provide a starting point for phrase analysis. Software tools for such word segmentation are publicly available (e.g. “Stanford Word Segmenter”, http://nlp.standford.edu/software/segmenter.shtml).

Meaningful combinations of words can be determined by n-gram analysis. Such analysis applies statistical probability of two characters or words appearing side by side in a text. In the embodiment illustrated herein, a phrase database is used to lookup the frequency of word combinations appearing in a phrase and this frequency is used in processing logic for determining whether to combine adjacent words as a phrase in a single display element. The illustrated embodiment parses text into single-word phrases and two-word phrases. However, if a phrase consisting of two words in Chinese text would exceed the length of five characters, then the words are not displayed as part of the same display element, but rather are displayed serially in consecutive display elements. This avoids exceeding a visual span of readers and triggering a saccade.

Turning now to FIG. 6b, step 660 sets the word selector variable (“wsel”) to 1. This variable identifies each word of a sentence with a number in ascending order beginning with “1” for the first word of the sentence. Step 660 also initializes the array Phrase[ ], which is used to store the phrases in the sentence (and provides the values for the variable “Phrase” in the array “Phases [ ]” of FIG. 6a).

Step 661 determines whether there are at least three words remaining in the sentence by determining whether wsel<the total words in the sentence —2. If the result of step 661 is no (i.e., there are fewer than three words remaining to be processed in the sentence) then the process continues with step 684 in FIG. 6c.

If the result of step 661 is yes (i.e., there are still three or more words remaining to be processed in the sentence), then steps 662-666 set variable values using the next three words to be processed as follows: Step 662 sets the variable “first_word” equal to the word corresponding to the current values of wsel (e.g., the first time step 662 executes for a sentence, the value of “first_word” would be the first_word in the sentence). Step 663 sets the variable “second_word” equal to the word corresponding to wsel+1 (i.e., the word following the word set equal to “first_word in step 663). Step 664 sets the variable “third_word” equal to the word corresponding to wsel+2 (i.e., the word following the word set equal to “second_word” in step 663). Step 665 sets the variable “current_phrase” equal to first_word followed by second_word, i.e., first_word second_word. Similarly, step 666 set the variable “next_phrase” equal to second_word followed by third_word.

Step 667 determines whether the value of current_phrase is longer than five characters. If the result of step 667 is no, then step 668 determines whether the value of current_phrase is listed in the phrase database (i.e., a database of known Chinese phrases). If yes, then step 669 determines whether the value of next_phrase is longer than five characters. If the result of step 669 is yes, then step 680 sets the next empty row in the array Phrase [ ] equal to current_phrase and step 681 sets the value of the next empty row (i.e., following the row filled in step 680) equal to third_word. If the result of step 669 is no, then step 670 determines whether the value of next_phrase is listed in the phrases database. If no, then steps 680 and 681 set the value of the next two empty rows of the array Phrase [ ] as describe above. If the result of step 670 is yes, then step 671 determines whether the value of next_phrase is a phrase that is used more frequently than the phrase that is the value of current_phrase. This example assumes that the phrase database list phrases and also lists a value for each listed phrase's use-frequency so that the frequency of use of two phrases can be compared. In a preferred embodiment, the phrase database treats idioms as phrases so that such phrases can be displayed together if the length does not exceed five characters. One example of data for idiom frequency is provided in the book “500 Common Chinese Idioms: An Annotated Frequency Dictionary,” by Jiao, Kubler, and Zhang, published by Routledge, 2011. Much larger compilations of Chinese phrases with frequency data are also available. See, for example, http://chengyu.itlearner.com/. If the result of step 671 is no, then steps 680 and 681 set the value of the next two empty rows of the array Phrase [ ] as describe above. If the result of step 671 is yes, then step 682 sets the next empty row in the array Phrase [ ] equal to first_word and step 681 sets the value of the next empty row (i.e., following the row filled in step 680) equal to next_phrase.

If the result of step 667 is yes, then step 672 sets the next empty row in the array “Phrase” equal to first_word. Step 673 then determines whether the value of next_phrase is longer than five characters. If the result of step 673 is no, then step 677 determines whether the value of next_phrase is listed in the phrase database. If yes, then step 678 sets the next empty row in the array Phrase [ ] equal to the value of next_phrase. If the result of step 673 is yes (next_phrase is longer than five characters), then step 674 sets the next empty row in the array Phrase [ ] equal to second_word. Step 675 then increments wsel by two and the process retunes to step 661. Note that in this situation, the value of first_word on the next loop will be the same as the value of third_word from the prior loop. Similarly, if the result of step 677 is no (i.e. next_phrase is not listed in the phrase database), then step 674 and 675 also proceed as just described.

If the result of step 668 is no (i.e., current_phrase is not listed in the phrase database), then step 676 sets the next row of the array Phrase [ ] equal to first_word. Step 677 then determines whether next_phrase is listed in the phrase database and processing continues from step 677 as described above.

If processing has followed paths in which steps 681, 683, or 678 are executed, then step 679 (rather than step 675) is executed. Step 679 increments wsel by three and processing returns to step 661.

If the result of step 661 is no, this implies that there are only one or two words remaining in the sentence. Processing then proceeds to step 684 in FIG. 6c.

Turning to FIG. 6c, step 684 stores the word corresponding to the current value of wsel as the value of the variable first_word. Step 685 then determines whether wsel+1>the number of words in the sentence. In other words, step 685 determines whether there is only one word remaining in the sentence. If the result of step 685 is yes, then step 686 sets the next empty row in the array Phrase [ ] equal to the value of first_word and processing 606 then ends at 694. Processing of the words in the sentence are completed.

If the result of step 685 is no, then step 687 stores the word corresponding to wsel+1 as the value of the variable second_word. Step 688 then stores the value of the variable current_phrase as the value of first_word followed by the value of second_word (i.e., current_phrase=first_word second_word). Step 689 then determines whether current_phrase is longer than five characters. If yes, then step 690 sets the next empty row of the array Phrase [ ] equal to the value of first_word and step 691 sets the next empty row (i.e., the row following the row set in step 690) equal to the value of second_word. Processing then ends at 694.

If the result of step 689 is no, then step 692 determines whether the value of current_phrase is in the phrase database. If no, then step 690 and 691 proceed as just described above. If the result of step 692 is yes, then step 693 sets the next empty row of the array Phrase [ ] equal to current_phrase. Processing then ends at 694.

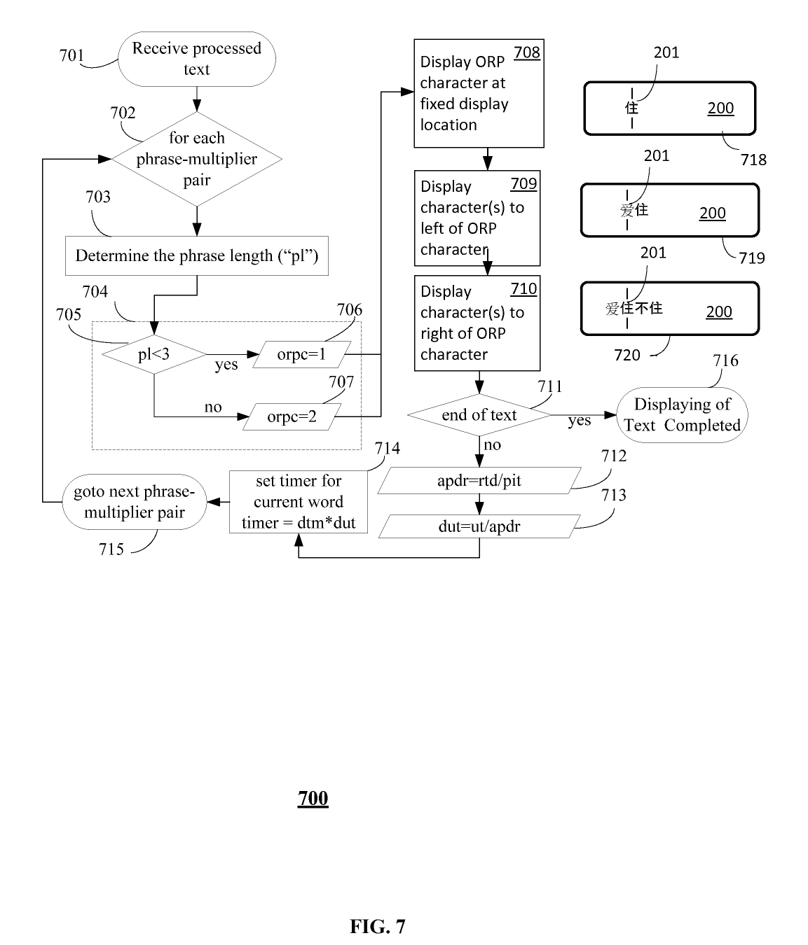

FIG. 7 provides a flow chart of processing 700 which illustrates further details of processing carried by computer application 300 of the embodiment of FIG. 3. Specifically, processing 700 is carried out by ORP display processor 307 of FIG. 3. In the embodiment illustrated in FIG. 7, ORP display processor 307 implements the ORP character position method previously described. In particular, an ORP character is identified and placed at fixed display location 201. Processing 700 begins at step 701 which receives processed text from ORP text processor 303 or from stored text data 311 (shown in FIG. 3).

Step 702 selects and loads the next phrase-multiplier pair of values to be processed from the array Phrases [ ] (stored in step 640 shown in FIG. 6a). This is either the first pair of values Phrase, dtm on an initial processing loop, or a next set in response to step 715. Step 703 calculates the phrase length pl in the same manner as step 608 of FIG. 6a, i.e., the phrase length in this embodiment is the number of characters excluding punctuation. Note that, in alternative embodiments, the phrase length calculated at step 608 of FIG. 6a could be stored in the array Phrases [ ] (along with the display element and the display time multiplier) so that it does not have to be recalculated in step 703.

Steps 704 then sets the ORP character (“orpc”) based on the value of pl by progressively testing the length until the appropriate value of orpc is selected for that phrase. The resulting orpc determination accords with the recommendations in TABLE I. Step 705 determines if pl<3. If the result of step 705 is yes, then step 706 sets the orpc to 1 (i.e., the orpc is set be the first character) and processing 700 proceeds to step 708. If the result of step 705 is no, then step 707 sets the orpc to 2 (i.e., the orpc is set be the second character) and processing 700 proceeds to step 708.

Step 708, displays ORP character (as selected by step 706 or 707) at fixed display location 201 in ORP display 200 (as illustrated by way of example in window 718). Step 709 then displays the characters to the left of the ORP character one-by-one with the offset defined by the font width (as illustrated by way of example in window 719). Step 710 then displays characters to the right of the ORP character are then displayed in the same manner (as illustrated by way of example in the window 720).

Step 711 then tests to see if the end of the text has been reached. If the result of step 711 is no, then step 712 calculates the average phrase relative duration (“apdr”) by dividing the rtd by the pit. Step 713 then calculates the default update time (“dut”) by dividing the update time (“ut”) (which is retrieved from display settings module 308 of FIG. 3) by the apdr. Step 714 then sets a timer and the phrase is displayed for a time equal to the product of the relative time multiplier (rtm) and the dut. Step 715 directs that the next phrase-multiplier pair is selected and processing 700 returns to step 702 so that the next phrase-multiplier pair can be processed. If the result of step 711 is yes, then display processing ends at step 716.

FIG. 8 provides a flow chart of processing 800 in accordance with an alternative to the embodiment of FIG. 7 for the processing of ORP display processor 307. Specifically, in the embodiment of FIG. 8, the ORP ratio position method referenced earlier is used. Rather than using an identified ORP character, processing 800 utilizes a proportionate position for the optimal recognition position which, multiplied by the phrase width, provides an offset value from the fixed display location for placing a pixel that is at the beginning of the phrase.

In most digital representations of Chinese texts, the characters all have identical width. The same width is used for displaying punctuation marks even though punctuation marks are typically not as wide as a character. Therefore, the pixel width allocated to a punctuation mark is typically greater than the visible width of the display punctuation mark. Also, punctuation marks are typically displayed closer to the left edge of the allocated pixel width than to the right edge. The visible width of a word with a punctuation mark in the end can be shorter than the sum of the word's character spaces. This deviation should be considered when determining the ORP based on proportionate position relative to the width of the word in pixels.

If no punctuation marks are shown together with the word or phrase in the display element, then a formula for calculating the ORP Offset can be written as follows:

ORP Offset=(Width*0.3)

“Width” is the total width (in pixels) of the phrase in the display element.

If punctuation marks are shown together with the phrase, then the ORP Offset can be calculated with the following formula:

ORP Offset=(Width+Right Punctuation Mark Width—Left Punctuation Mark Width)*0.3

“Right Punctuation Mark Width” and “Left Punctuation Mark Width” describe the width in pixels for the punctuation marks. The width of the displayed portion of a single punctuation mark is generally less than a character's displayed width. Therefore, in calculating the displayed width of a punctuation mark, it might be necessary to trim, i.e. reduce, the value of the display width amount that is normally allocated to a full character. In some cases, two or more punctuation marks might be displayed consecutively after and/or before the phrase. In one embodiment, the relevant variables, i.e., Right Punctuation Mark Width and/or Left Punctuation Mark Width are determined by calculating a combined displayed width of adjacent punctuation marks (on the left and/or right end of the displayed phrase). This can be done, in one embodiment, as follows: adding the full reserved width for any inner punctuation marks (i.e., a mark adjacent to the outermost mark) to the reserved width for the outermost punctuation mark (e.g., the further to the left or furthest to the right), and then trimming, i.e., reducing, the value of the reserved width of the outermost punctuation mark only.

In an alternative embodiment, punctuation marks are ignored for purposes of determining the ORP offset. In such an embodiment, punctuation marks can be shown with the phrase; however, positioning of the phrase is determined using only the above Width value, which provides the displayed width of the phrase (including only the characters in the phrase without punctuation marks). The ORP Offset is then used to determine where to place the beginning pixel of the phrase's first Chinese character (rather than using the ORP Offset to determine where to place the beginning pixel of any left-side punctuation mark). Any left-side punctuation marks would be displayed to the left of that character and any right-side punctuation marks would be displayed to the right of the phrase's last character.

Step 801 receives text from the ORP text processor 303 or from text data store 311. Step 802 selects and loads the next phrase-multiplier pair of values to be processed from the array Phrases [ ] (stored in step 640 shown in FIG. 6a). This is either the first pair of values Phrase, dtm on an initial processing loop, or a next set in response to step 816. Step 803 then calculates the total width of the phrase (“pw”) in pixels and the character width (“cw”) in pixels. As previously discussed, the word “width” in this context is calculated along the same dimension (in line with the reading direction) as is the word “length” referenced in the context earlier figures. The difference is that as used herein, “pw” is measured in pixels and “pl” is measured in number of characters. Also, while the present embodiment assumes that the Chinese characters will all have identical display widths, the embodiment can be modified to accommodate a proportionally spaced font representation in which different characters have different displayed width. In such an alternative, an average character width (“acw”) for the characters in the current phrase can be calculated and the acw value can be used in place of the Character Width (“cw”) value referenced in the above ORP Offset formula.

Step 804 determines if the current phrase includes punctuation marks. If the answer in step 804 is no, then step 805 determines the first pixel position for the display of the phrase in RSVP display 200 (an exemplary ORP display 200 is shown just below step 805 in FIG. 819) by calculating the ORP ratio offset (“ORPRO”) as the pw multiplied by 0.3. If the answer in step 804 is yes, then step 806 determines if there is a punctuation mark (or marks) at the right side. If the answer is yes then step 807 determines the punctuation width at the right side “puwr” and step 808 determines there is a punctuation mark (or marks) at the left side of the phrase. If the answer is yes then step 809 determines the punctuation width at the left side “puwl.” If the answer in step 806 is no, then step 808 determines if punctuation marks are connected to the left side of the phrase. If the answer is yes then step 809 determines the punctuation width at the left side puwl. Note that the determinations regarding punctuation widths to the left and/or right of the phrase in steps 807 and 809 take into account the displayed width rather than the reserved width of the left-most or right-most punctuation mark as discussed above in paragraph [0095]. Step 810 determines the initial pixel position by calculating the ORP Ratio Offset with consideration of punctuation marks to the right and/or the left of the phrase. Specifically, in this example, step 810 calculates the ORPRO as 0.3 multiplied by the sum of pw+puwr−puwl. In step 811, the phrase is displayed with the first pixel of the first character located at the ORPRO position 818 (which is a distance in pixels equal to the ORPRO from the fixed display location 201). This may be referenced as the “beginning pixel” of the phrase from the perspective of a reading direction of a reader of the display. Different display positions with punctuation marks connected to the displayed phrase are shown in windows 820, 821 and 822.

When the beginning pixel is displayed at the ORPRO from fixed display location 201, the ORP of the phrase, which in this case is identified as the optimal proportionate position along the width of the phrase (rather than being identified as a particular character), will be displayed at fixed display location 201.

Step 812 tests to see if the end of the text has been reached. If the result of step 812 is no, then step 813 calculates the average phrase relative duration (“apdr”) by dividing the rtd by the pit. Step 814 then calculates the default update time (“dut”) by dividing the update time (“ut”), which is retrieved from the display settings module 308, by the apdr. Step 815 then sets a timer and the phrase is displayed for a time equal to the product of the relative time multiplier and the dut. Step 816 directs that the next phrase-multiplier pair is selected and processing 800 returns to step 802 so that the next phrase-multiplier can be processed. If the result of step 812 is yes, then display processing 800 ends at step 817.

The example of FIG. 8 uses 0.3 as a fixed proportion of the phrase that is displayed to the left of the ORP. Empirical study by the inventor with Chinese native speakers has determined that this value works well. However, different empirical studies can be performed that might identify somewhat different values that would also work well. Furthermore, in one alternative embodiment, the ORP character position ratios from TABLE I can be used in place of 0.3 such that the ratio value used varies depending on the number of characters. Alternatively, those values could be used to calculate an “average character position ratio” that can be used as a fixed value in place of 0.3 for display of phrases of any length (using the values in TABLE I, that value would be 0.39). Preferably, for at least phrases having a length of four or more characters, a position that is off-center toward the beginning of the phrase is placed at the fixed display location. In the primary embodiment illustrated herein, which uses 0.3 to determine the proportionate position for all display elements, phrases of any length are displayed placing a position that is off-center towards the beginning of the phrase at the fixed display location. Such off-center placement toward the beginning of the phrase will more important for reducing saccades in the case of longer phrases (for example, four or five characters in length). However, for ease of implementation (and in view of the inventor's empirical results to date with respect to phrases that are three or more characters in length), the primary embodiment uses 0.3 for any length phrase.

As an alternative to processing all text before beginning the display processing, it is possible to display each display element (e.g., a word) after it has been processed. Referencing such an alternative in the context of modifying the processing order of steps shown in FIG. 6 and FIG. 7 (which implements the ORP character position method), the order of steps would be modified as follows: After step 615, the processing would proceed to step 703. After step 720, then the processing would return to step 606 in order to prepare the next word for display. If step 614 determined that it is a blank element, then step 617 would proceed in order to prepare the blank element for display in step 714. Then the processing would return to step 624 to continue the processing of the next sentence or it reaches the end of text processing and display processing.

Referencing such an alternative in the context of modifying the processing order of steps shown in FIG. 6 and FIG. 8 (which implements the ORP ratio position offset method), after step 615, the next step would be step 803. After step 810, the processing would then return to step 606 in order to prepare the next word for display. If step 614 determined that it was a blank element, then step 617 would proceed in order to prepare the blank element for display in step 810. Then the processing returns to step 624 to continue the processing of the next sentence or it reaches the end of text processing and display processing.

In serial text display, saccades are most noticeably a problem for words that are five or more characters in length. Therefore, a preferred embodiment of the present invention places the ORP at the fixed display location at least for display elements that are five or more characters in length. For such display elements (and for display elements of length four), the optimal recognition position is off-center toward the beginning of the display element (from the perspective of a reader of the display). However, while display of the ORP at the fixed display location for words that are fewer than five characters length is not necessary for achieving the benefits of particular embodiments of the invention, in a preferred embodiment, words of lengths four or less are also displayed using the ORP character position method or the ratio position offset method (which, for word lengths of three or less, will not necessarily result in the fixed display location being off center toward the beginning of the word). However, when such words (length four or less) are displayed at the fixed display location, exactly which character or proportionate position of these words is displayed at the fixed display location is not necessarily critical for minimizing saccades. At the same time, however, displaying words of length four or less such that their optimal recognition position is at the fixed display location does provide some smoothing benefit in that eye displacement from one word to the next is reduced, and therefore a preferred embodiment places an optimal recognition potions of all words, including words of length four or less at the fixed display location.

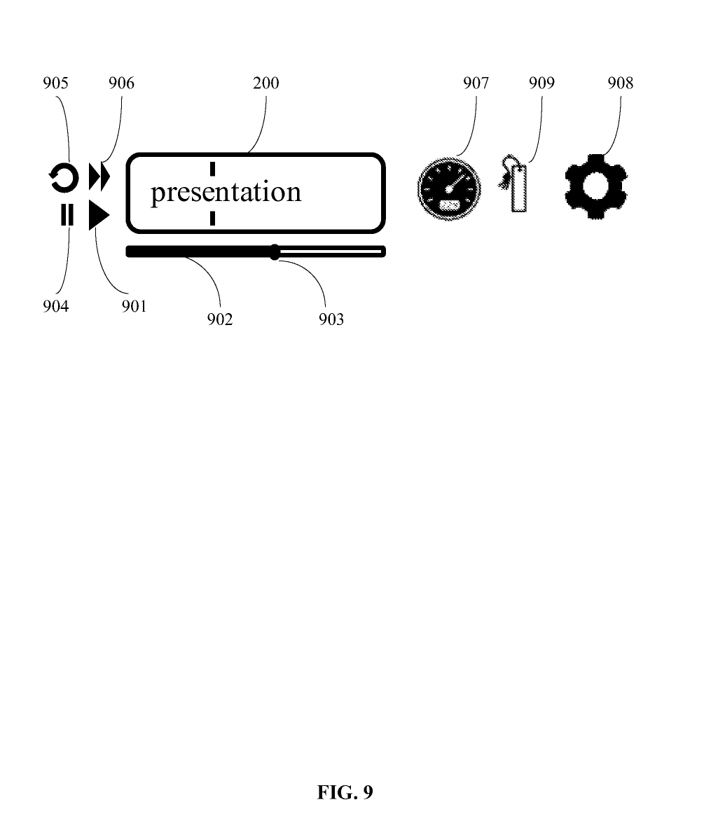

FIG. 9 illustrates several features that can be added to a basic embodiment of the present invention to improve its effectiveness. User interface 301 and ORP display 200 can be enhanced to enable the user to interact with the display process. As illustrated in FIG. 9, standard controls including starting control 901, pausing control 904, repeating control 905, and fast forwarding control 906 to control display of the text can be provided. A visual indicator 902 can be provided to indicate the progress of the display as a fraction of the total amount of text to be displayed. A slider 903 could also be used to enable jumping to any point in the text. An indicator 907 of the display speed in average words per minute could be provided, which could also enable the user to change the speed during the presentation. A bookmark icon 909 could enable the user to click and set a bookmark during the presentation, and provide the means to restart the presentation at the point that the bookmark was set. A settings icon 908 could be provided to enable the user to change for preferences for the presentation, such as the initial display speed, the color of the display background, the color or texture of the ORP indicators, and the text font type and size.

Other embodiments would enable the invention to be deployed on a variety of electronic devices, such as various computer operating systems, mobile phone operating systems, video gaming platforms, and portable electronic devices such as digital watches, cameras, and music players. While the basic embodiment described herein provides for ORP processing of text that is stored locally on the electronic device, it is possible that the text in a standard format or preprocessed ORP format could be streamed to the electronic device from a server via a wired or wireless network connection. While a preferred embodiment of the present invention is the display of text on small displays, if a large display is available then it would be possible to display the full text in a companion display, such that the progress through the text can be indicated by a moving highlight that corresponds to the word being currently display in the ORP Display.

### Additional Embodiments

Method(s), computer program product(s), and/or system(s) for displaying text comprising Chinese characters by at least:
parsing the text into a plurality of display elements to be displayed on an electronic display using rapid serial visual presentation (RSVP), each display element comprising a phrase comprising five or fewer characters;
determining whether to modify a default time for displaying a phrase of a display element of the plurality of display elements during RSVP using one or more of the following factors: (i) complexity of Chinese characters in the display element phrase and (ii) use-frequency of Chinese characters in the display element phrase; and
displaying the display elements using RSVP wherein a display time of a display element depends on the results of determining whether to modify the default time.

The embodiment of paragraph [00107] wherein one or more of the factors further includes use-frequency of the display element phrase.

The embodiment of paragraph [00107] wherein one of more of the factors further includes use-frequency of one or more words in the phrase.

The embodiment of paragraph [00107], [00108], or [00109] wherein parsing comprises parsing the text into words and then parsing the text into phrases comprising one or two words of the text.

The embodiment of paragraph [00107], [00108], or [00109] wherein parsing comprises parsing the text into words and then parsing the text into phrases by, for a set of three consecutive words in the text, making a first determination regarding whether a first and second word comprise a first phrase that is five characters or less in length, making a second determination regarding whether a second and third word comprise a second phrase that is five characters or less, and, if the first determination and the second determinations are yes, then making a third determination regarding whether the first phrase is used more frequently than a second phrase.

The embodiment of paragraph [00111] wherein if the first phrase is used more frequently than the second phrase, then parsing the three words into one phrase comprising the first and second word and another phrase comprising the third word and if the second phrase is used more frequently than the first phrase, then parsing the three words into one phrase comprising the first phrase and another phrase comprising the second and third word.

The embodiment of paragraph [00107], [00108], or [00109] wherein the embodiment displays one or more visual indicators marking a fixed location on the electronic display and the embodiment displays at least some of the phrases such that an optimal recognition position of the phrase is displayed at the fixed display location.

The embodiment of paragraph [00113] wherein, for a phrase that is four or five characters in length, the phrase is displayed with the second character at the fixed display location.

The embodiment of paragraph [00107], [00108], or [00109] wherein the embodiment displays one or more visual indicators marking a fixed location on the electronic display and the embodiment displays at least some of the phrases such that a location that is between 0.2 and 0.4 of the display element's visual width is placed at the fixed display location.

The embodiment of paragraph [00107], [00108], or [00109] wherein the embodiment displays one or more visual indicators marking a fixed location on the electronic display and the embodiment displays at least some of the phrases such that a location that is off-center towards the beginning of the display element's visual width is placed at the fixed display location.

While the present invention has been particularly described with respect to the illustrated embodiments, it will be appreciated that various alterations, modifications and adaptations may be made based on the present disclosure and are intended to be within the scope of the present invention. While the invention has been described in connection with what are presently considered to be the most practical and preferred embodiments, it is to be understood that the present invention is not limited to the disclosed embodiments but, on the contrary, is intended to cover various modifications and equivalent arrangements included within the scope of the underlying principles of the invention as described by the following claims.

1. A method for displaying text comprising Chinese characters on an electronic display, the method comprising:
parsing the text into a plurality of display elements to be displayed on the electronic display using rapid serial visual presentation (RSVP), each display element comprising a phrase comprising five or fewer characters;
determining whether to modify a default time for displaying a display element of the plurality of display elements during RSVP display based at least in part on a complexity of Chinese characters in the display element; and
displaying the display elements using RSVP wherein a display time of a display element depends on the results of determining whether to modify the default time.

2. The method of claim 1 wherein determining is further based at least in part on a use-frequency of Chinese characters in the display element's phrase.

3. The method of claim 1 wherein determining is further based at least in part on a use-frequency of the display element's phrase.

4. The method of claim 1 wherein determining is further based at least in part on use-frequency of one or more words in the phrase.

5. The method of claim 1 wherein parsing comprises parsing the text into words and then parsing the text into phrases comprising one or two words of the text.

6. The method of claim 1 wherein parsing comprises parsing the text into words and then parsing the text into phrases by, for a set of three consecutive words in the text, making a first determination regarding whether a first and second word comprise a first phrase that is five characters or less in length, making a second determination regarding whether a second and third word comprise a second phrase that is five characters or less, and, if the first determination and the second determinations are yes, then making a third determination regarding whether the first phrase is used more frequently than a second phrase.

7. The method of claim 6 wherein if the first phrase is used more frequently than the second phrase, then parsing the three words into one phrase comprising the first and second word and another phrase comprising the third word and if the second phrase is used more frequently than the first phrase, then parsing the three words into one phrase comprising the first phrase and another phrase comprising the second and third word.

8. The method of claim 1 further comprising:
displaying one or more visual indicators marking a fixed location on the electronic display; and
displaying at least some of the phrases such that an optimal recognition position of the phrase is displayed at the fixed display location.

9. The method of claim 8 wherein, for a phrase that is four or five characters in length, the phrase is displayed with the second character at the fixed display location.

10. The method of claim 1 further comprising:
displaying one or more visual indicators marking a fixed location on the electronic display; and
displaying at least some of the phrases such that 0.2 to 0.4 of a phrase's visual width is displayed from a beginning pixel of the displayed phrase to the fixed display location.

11. The method of claim 1 further comprising
displaying one or more visual indicators marking a fixed location on the electronic display; and
displaying at least some of the phrases such that a location that is off-center towards the beginning of the display element's visual width is placed at the fixed display location.

12. The method of claim 1 further comprising:
determining if a phrase to be displayed is a last phrase in a sentence; and
if the phrase to be displayed is a last phrase in a sentence, determining a multiplier for modifying the default display time for displaying the phrase based at least in part on a number of words in the sentence.

13. The method of claim 12 wherein, if the number of words in the sentence is eleven or less, then the multiplier is determined to a first value.

14. The method of claim 12 wherein, if the number of words in the sentence is greater than or equal to twelve eleven and less than or equal to twenty-two, then the multiplier is determined to be a second value greater than the first value.

15. The method of claim 12 wherein, if the number of words in the sentence is greater than twenty-two, then the multiplier is determined to be a third value greater than the second value.

16. The method of claim 15 wherein the first value is equal or approximately equal to 2.1, the second value is equal or approximately equal to 3.2 and the third value is equal or approximately equal to 4.3.

17. The method of claim 1 wherein complexity of a character is determined by a database lookup.

18. The method of claim 1 wherein complexity of a character is determined based on a number of strokes in the character.

19. The method of claim 18 wherein a character is determined to be complex if it comprises more than ten strokes.

20. The method of claim 1 wherein a number of characters in a phrase that are determined to be complex is used to determine whether to display the phrase for longer than the default display time.

21. The method of claim 1 wherein a phrase is displayed for longer than the default display time if a value determined as a function of a number of complex characters in the phrase, a use-frequency of characters in the phrase, and a use-frequency of the phrase exceeds a pre-determined value.

22. A computer program product in a non-transitory computer readable medium comprising instructions that, when executed by a computer processor, prepare text comprising Chinese characters for display on an electronic display by at least:
parsing the text into a plurality of display elements to be displayed on the electronic display using rapid serial visual presentation (RSVP), each display element comprising a phrase comprising five or fewer characters; and
determining whether to modify a default time for displaying a phrase of a display element of the plurality of display elements during RSVP display based at least in part on a complexity of Chinese characters in the display element phrase;
wherein when the display elements are displayed using RSVP, a display time of a display element depends on the results of determining whether to modify the default time.

23. The computer program product of claim 22 wherein determining is further based at least in part on a use-frequency of Chinese characters in the display element phrase.

24. The computer program product of claim 23 wherein determining is further based at least in part on a use-frequency of the display element phrase.

25. The computer program product of claim 23 wherein determining is further based at least in part on use-frequency of one or more words in the phrase.

26. The computer program product of claim 22 wherein parsing comprises parsing the text into words and then parsing the text into phrases comprising one or two words of the text.

27. The computer program product of claim 22 wherein parsing comprises parsing the text into words and then parsing the text into phrases by, for a set of three consecutive words in the text, making a first determination regarding whether a first and second word comprise a first phrase that is five characters or less in length, making a second determination regarding whether a second and third word comprise a second phrase that is five characters or less, and, if the first determination and the second determinations are yes, then making a third determination regarding whether the first phrase is used more frequently than a second phrase.

28. The computer program product of claim 27 wherein if the first phrase is used more frequently than the second phrase, then parsing the three words into one phrase comprising the first and second word and another phrase comprising the third word and if the second phrase is used more frequently than the first phrase, then parsing the three words into one phrase comprising the first phrase and another phrase comprising the second and third word.

29. A method for displaying text comprising Chinese characters on an electronic display, the method comprising:
parsing the text into a plurality of display elements to be displayed on the electronic display using rapid serial visual presentation (RSVP), each display element comprising a phrase comprising five or fewer characters;
determining, for respective display elements of the plurality of display elements, respective display time multipliers for modifying a default time for displaying the respective display elements during RSVP display wherein a respective display time multiplier is determined based at least in part on a complexity of Chinese characters in a respective display element; and
transmitting the respective display elements and respective display time multipliers to a client device for displaying the display elements using RSVP on an electronic display of the client device wherein a display time of a display element depends at least in part on a display time multiplier corresponding to the display element.

30-35. (canceled)
